(19) United States
(12) Patent Application Publication
(10) Pub. No.: US 2026/0122529 A1
(43) Pub. Date: Apr. 30, 2026

(54) DYNAMIC QUALITY OF SERVICE CONFIGURATION

(71) Applicant: T-Mobile Innovations LLC, Overland Park, KS (US)

(72) Inventors: Wafik ABDEL SHAHID, Kenmore, WA (US); Ming Shan KWOK, Seattle, WA (US)

(21) Appl. No.: 18/925,162

(22) Filed: Oct. 24, 2024

(51) Int. Cl. H04W 28/02

(52) U.S. Cl. CPC H04W 28/0268; H04W 28/0263

(57) ABSTRACT

Methods and systems provided herein include a wireless device that monitors flow requirements of applications, activities and/or services. Further, the wireless device may request a dedicated bear from an access node upon determining that an existing bearer is unable to provide a required QoS based on the one or more flow requirements.

### TECHNICAL BACKGROUND

As wireless networks evolve and grow, challenges arise in providing a satisfactory quality of service (QoS) for all network users. Typically, a wireless network utilizes a set of rules to prioritize traffic within a network. The network prioritizes and provides maximum speeds for some data, while slowing down other types of data or devices. For example, the network settings may prioritize high-demand activities like online gaming and video while slowing down traditional website performance. However, network operators often lack sufficient information to select and implement these rules for the benefit of all network users.

QoS is configured and assigned based on an umbrella of attributes such as data network name (DNN), traffic flow templates (TFT), and priority. Those attributes are used for traffic flows such as browsing, streaming, interactive and background applications without distinguishing between the required characteristics and priority of each application or activity.

Accordingly, from a scheduling perspective, this process results in all applications being treated the same during a protocol data unit (PDU) session when it comes to scheduling, buffer status report (BSR) reporting and transportation of associated flows. In some cases, the identical treatment of all flows during a session causes low latency and/or high bandwidth (BW) applications to experience degraded performance.

Given the many different types of devices and different applications and services, such as for example, gaming applications, online meeting applications such as WebEx®, virtual reality (VR) applications, augmented reality (AR) applications, streaming applications, messaging applications, cloud services, file transfer applications, social media applications, monitoring applications, security applications, and voice applications, differential QoS for different activities during a session may be desirable in order to ensure adequate performance.

Typically, all flows belonging to the same PDU session receive the same traffic prioritization from the wireless device, the radio access network (RAN) and the core network.

Accordingly, a need exists to prioritize different flows and treat them differently.

### Overview

Exemplary embodiments provided herein include a method for dynamically configuring a quality of service (QoS) from a wireless device. In some embodiments, the method includes learning, by a wireless device, flow requirements of an activity performed in a wireless network by the wireless device and determining a target quality of service (QoS) for the activity based on the flow requirements. The method further includes triggering a request from the wireless device to a radio access network (RAN) for the target QoS for the activity during a protocol data unit (PDU) session.

Further aspects include a wireless device configured to dynamically request a particular QoS from a radio access network (RAN). The wireless device includes a memory storing multiple mobile applications and a processor incorporating artificial intelligence markup language (AIML) used to perform multiple operations. The operations include learning flow requirements of an activity of the wireless device and determining a target quality of service (QoS) for the activity based on the flow requirements. The operations further include triggering a request from the wireless device to the RAN for the target QoS for the activity.

In yet further aspects, a method is provided for dynamically requesting a QoS from a wireless device. The method includes learning, by an artificial intelligence markup language (AIML) chip on a wireless device, flow requirements of activities performed by the wireless device within a wireless network during a protocol data unit (PDU) session. The method further includes determining, by the AIML chip, a corresponding target quality of service (QoS) for each activity performed during the PDU session. Additionally, the method includes triggering a request from the AIML chip for the corresponding target QoS for the activities performed during the session when the corresponding target QoS differs from a default QoS.

Yet further aspects include a system and non-transitory computer-readable medium for determining and requesting a target QoS from a wireless device.

### BRIEF DESCRIPTION OF THE DRAWINGS

FIG. 1 depicts an exemplary environment for providing dynamic quality of service (QoS) in accordance with an embodiment.

FIG. 2 depicts an exemplary wireless device in accordance with an embodiment.

FIG. 3 depicts an exemplary access node in accordance with an embodiment.

FIG. 4 depicts a further exemplary environment for dynamic QoS configuration in accordance with an embodiment.

FIG. 5 depicts an exemplary method for dynamic QoS configuration in accordance with an embodiment.

FIG. 6 depicts a further exemplary method for providing dynamic QoS configuration in accordance with an embodiment.

FIG. 7 depicts a further exemplary method for providing dynamic QoS configuration in accordance with an embodiment.

### DETAILED DESCRIPTION

Embodiments provided herein include a method, system, and wireless device for dynamic quality of service (QoS) configuration. Traffic prioritization is typically configured by wireless network providers or by applications or associated network nodes. Traditional QoS control methods fail to address user needs as users increasingly utilize different applications and engage in different activities during a protocol data unit (PDU) session. Accordingly, embodiments provided herein allow for wireless devices to dynamically request a particular QoS for an activity.

Embodiments described herein utilize artificial intelligence markup language (AIML) on a chipset of a wireless device or user equipment (UE) in order to learn flow requirements of different applications and activities and request unique bearers to be established in the uplink direction for specific flows without having to use a different data network name (DNN). The DNN is used to identify and route traffic to a specific network slice. Network slices can be customized with specific QoS requirements for different services and applications, but the customization does not occur in real time. AIML is an extensible markup language (XML) dialect used to create natural language software agents like chatbots, virtual assistants, and other forms of artificial intelligence software. The more rules added to AIML, the more intelligent the software agent becomes.

Initially, in a learning stage, the AIML chip monitors applications and activities performed on the wireless device. The applications or activities may include, for example, gaming, extended reality (XR), browsing, file downloads/uploads, streaming and interactive applications. Each of these applications and activities may have different and distinctive flows and the AIML chip may identify and distinguish between the different flows with respect to flow requirements such as latency and bandwidth. Further, the AIML chip may examine a radio bearer setup between the RAN and the wireless device and record the characteristics of the radio bearer setup including priority and traffic flow template (TFT) filters. The radio bearer is a logical channel established between the base station and the wireless device for carrying both user data and control data.

The TFTs are installed at the wireless device and at the core network in order to determine if a particular traffic stream needs to traverse a particular bearer. As such, when a bearer is established, an uplink TFT is installed at the wireless device and a downlink TFT is installed at the core network.

Through artificial intelligence (AI) processing, the AIML chip detects a flow requiring low latency such as a gaming or XR application. In this case, the provided radio bearer may have insufficient QoS for adequate performance. Thus, the AIML chip may trigger a modem of the wireless device to request a dedicated bearer having a priority and TFT filters sufficient for the latency sensitive application to utilize on the uplink.

In embodiments described herein, the requested radio bearer will be maintained to be used for the identified flows throughout the PDU session and then will be de-configured when the PDU session terminates. Termination of the bearer when the application is no longer in use is performed to free up resources on the RAN and core network.

This development improves upon the current configuration in which all flows belonging to the same PDU session get the same priority and same traffic prioritization from the wireless device, the RAN, and the core. Currently, for latency sensitive applications or mission critical use cases, no real-time technique exists for differentiating treatment of different flows during a PDU session. While currently, only one radio bearer may be provided for a PDU session, embodiments provided herein provide more than one bearer per PDU session.

Accordingly, in embodiments described herein, a wireless device running an AIML machine to detect different flow requirements is described. The QoS on uplink can be modified to facilitate the required latency and throughputs for the learned flow requirements as needed.

An exemplary environment described herein includes at least an access node (or base station), such as a next generation NodeB (gNodeB), and at least one end-user wireless devices. For illustrative purposes and simplicity, the disclosed technology will be illustrated and discussed as being implemented in the communications between an access node (e.g., a base station) and a wireless device (e.g., an end-user wireless device). In addition to the systems and methods described herein, the operations for dynamic QoS configuration may be implemented as computer-readable instructions or methods.

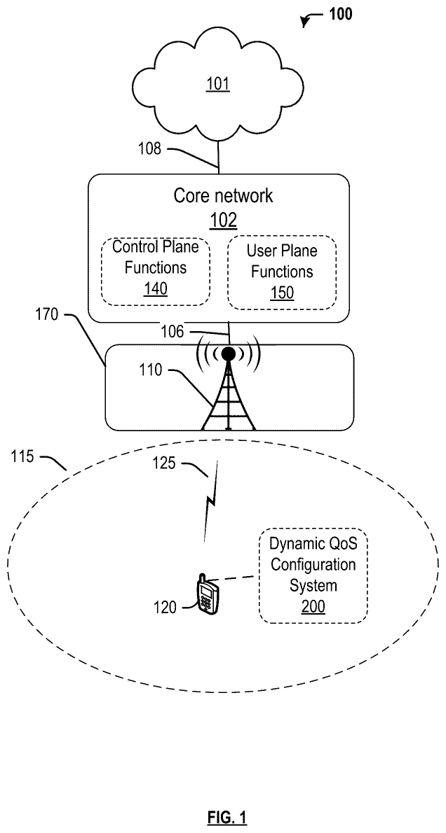

FIG. 1 depicts an exemplary environment 100 for implementing dynamic QoS configuration in a wireless network. In the displayed environment 100, a dynamic QoS configuration system 200 operates to learn flow requirements of applications and activities performed from a wireless device 120 within a coverage area 115. The wireless device 120 may be, for example, an enhanced mobile broadband (eMBB) device or any other type of wireless device capable of connecting with a wireless network.

Environment 100 comprises a communication network 101, core network 102, and a radio access network (RAN) 170 including at least an access node 110. Wireless device 120 communicates with the access node 110 via a wireless link 125. The dynamic QoS configuration system 200 operates to enable the wireless device 120 to request an elevated QoS from the access node 110 for a particular activity or application.

Additionally, components not shown may include, for example, gateway node(s) controller nodes, and additional access nodes. For example, a wireless network may include one or more access nodes, such as base stations including evolved NodeBs (eNBs) or next generation NodeBs (gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 6G or 4G long-term evolution (LTE) access nodes.

Access node 110 can be any network node configured to provide communication between end-user wireless device 120 and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like.

Further the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 120 are illustrated in FIG. 1, any number of access nodes and wireless devices can be implemented within environment 100.

The exemplary operating environment 100 may further include the dynamic QoS configuration system 200, which is illustrated as operating in conjunction with the wireless devices. In embodiments described herein, the dynamic QoS configuration system 200 is incorporated in the wireless device 120, but may also be distributed and include components at the access node 110 cooperating with the components of the wireless device 120.

The dynamic QoS configuration system 200 monitors activities performed on the wireless device 120 and applications running on the wireless device 120 to determine flow requirements of the applications and activities. Based on the flow requirements of the applications and activities, the dynamic QoS configuration system 200 determines a target quality of service for the application or activity. The dynamic QoS configuration system 200 may further learn characteristics of default bearers provided by the access node 110. When the target QoS exceeds a default QoS provided by the access node 110, the dynamic QoS configuration system 200 triggers a request to the access node 110 for a dedicated bearer that can provide the target QoS for the application or activity during a PDU session. If the access node 110 has resources, the access node 110 may provide the dedicated bearer during the PDU session. After the PDU session terminates, the default configuration may be restored.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes.

Further, the access node 110 may communicate with the dynamic QoS configuration system 200 and may partially incorporate the dynamic QoS configuration system 200. Thus, the dynamic QoS configuration system 200 may collect data at the wireless device 120 and may perform processing in order to trigger a request for a dedicated bearer having a target QoS from the access node 110.

Wireless device 120 may be any device, system, combination of devices, or other such communication platform capable of communicating wirelessly with access node 110 using one or more frequency bands deployed therefrom. For example, the wireless device 120 may be, for example, an eMBB device. The wireless device 120 may be or include, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. In embodiments described herein, the wireless device 120 includes an AIML chip for performing the methods described herein.

The core network 102 includes core network functions and elements. The core network may be structured using a service-based architecture (SBA). The network functions and elements may be separated into user plane functions 150 and control plane functions 140. In an SBA architecture, service-based interfaces may be utilized between control-plane functions, while user-plane functions connect over point-to-point link. The user plane functions (UPF) 150 access a data network, such as network 101, and perform operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless device 120 and is responsible for handling connection and mobility management tasks. The SMF is primarily responsible for creating, updating, and removing sessions and managing session context. The UDM function provides services to other core functions, such as the AMF, SMF, and NEF. The UDM function may provide a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device. Wireless network protocols can comprise multimedia broadcast multicast service (MBMS), code division multiple access (CDMA), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path, including combinations thereof. Communication links 106 and 108 can be wired or wireless and use various communication protocols such as Internet, Internet protocol (IP), local-area network (LAN), optical networking, hybrid fiber coax (HFC), telephony, T1, or some other communication format. Communication links 106 and 108 can be a direct link or might include various equipment, intermediate components, systems, and networks. Communication links 106 and 108 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

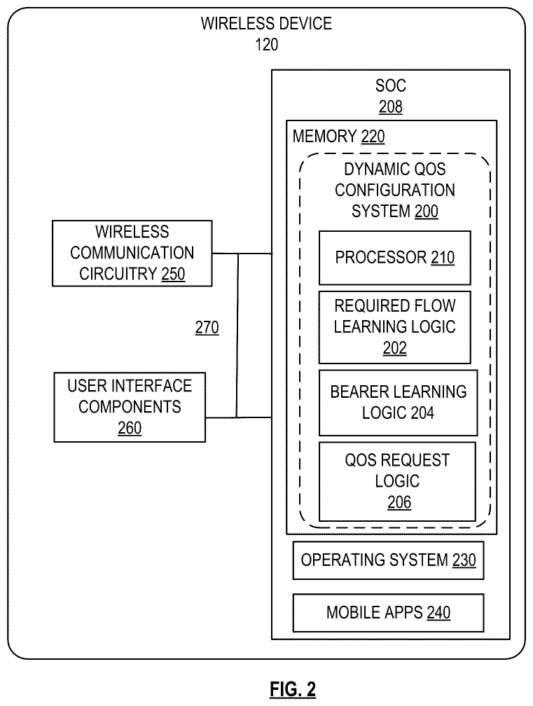

FIG. 2 illustrates a wireless device 120 incorporating a dynamic QoS configuration system 200. The components described herein are merely exemplary as many different configurations for both the wireless device 120 and the dynamic QoS configuration system 200 are within scope of the disclosure. The dynamic QoS configuration system 200 may be configured to perform the methods and operations disclosed herein in combination with the wireless device 120.

As illustrated, the wireless device 120 includes wireless communication circuitry 250, user interface components 260, and a system on chip (SoC) 208. The SoC 208 may be an AIML chip or other AI chip. The AIML or other AI chip 208 may be optimized to execute a large number of calculations in parallel rather than sequentially in order to facilitate learning. The SoC 208 may integrate various features such as an encoder/decoder, network interface card, peripheral devices, central processing unit (CPU), graphics processing unit (GPU), neural processing unit (NPU), an image signal processor (ISP), and a digital signal processor (DSP). A simplified version of SoC 208 is provided for purposes of description. SoC 208 may include a processor 210 and a memory 220 and may further include an operating system 230 and mobile apps 240. The processor 210 may contain at least one coprocessor, which may be microcontroller, microprocessor, or digital signal processor (DSP).

In embodiments disclosed herein, the SoC 208 is an AIML chip. Components may be connected, for example, by a bus 270. These components are merely exemplary and the wireless device 120 may include a larger or smaller number of components capable of performing the functions described herein. Wireless devices such as smartphones may have multiple microprocessors and microcontrollers. A microprocessor may have a bus to communicate with memory on separate chips and buses to communicate with the rest of the equipment.

The memory 220 may store, for example, components of the dynamic QoS configuration system 200. The components may include, for example, the processor 210, required flow learning logic 202, bearer learning logic 204, and QoS request logic 206.

Thus, in embodiments provided herein, the dynamic QoS configuration system 200 incorporates or operates in conjunction with the processor 210 or other processor on the SoC 208 to perform a method to trigger a request for a bearer having an elevated QoS for activities and applications having certain flow requirements. The required flow learning logic 202 may utilize AIML to learn flow requirements of activities and applications utilized by the wireless device 120 in order to ensure optimized QoS.

The wireless communication circuitry 250 may include circuit elements configured to generate wireless signals (e.g., one or more antennas) as well as interface elements configured, for example, to translate control signals from the SoC 208 into data signals for wireless output. The wireless communication circuitry 250 may include hardware components, such as network communication ports, devices, routers, wires, antenna, transceivers, etc. Further, the wireless communication circuitry 250 may include multiple elements, for example to communicate in different modes with different RATs. The SoC 208 may be configured to receive, interpret, and/or respond to signals received via the wireless communication circuitry 250. Wireless communication circuitry 250 may be configured to enable the processor 210 to communicate with other components, nodes, or devices in the wireless network. For example, the dynamic QoS configuration system 200 receives relevant parameters from the access node 110 or from the wireless device 120. The SoC 208 may be configured to receive a network command (e.g., from an access node 110) to perform other specified functions. The wireless communication circuitry 250 may further include a modem configured to request a dedicated bearer with required priority and TFT filters for latency sensitive applications to use for use in the uplink (UL) direction.

The user interface components 260 may be or include any components enabling a user to interact with the wireless device 120, including tools for managing the dynamic QoS configuration system 200. The user interface components 260 may be configured to allow a user to provide input to the dynamic QoS configuration system 200 and receive data or information from access node 110 and wireless device 120. The user interface components 260 may include hardware components, such as touch screens, buttons, displays, speakers, etc.

The memory 220 may include a RAM, read only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in the memory storage device 220 may include computer programs, firmware, or other form of machine-readable instructions, including an operating system, utilities, drivers, network interfaces, applications, or other type of software. For example, software stored in storage device 220 may include one or more modules for performing various operations described herein. Processor 210 may be a microprocessor and may include hardware circuitry and/or embedded codes configured to retrieve and execute software stored in storage device 220.

Thus, the wireless device 120 includes the processor 210 executing AIML logic including the required flow learning logic 202, bearer learning logic 204, and QoS request logic 206 of the dynamic QoS configuration system 200. The processor 210 may execute logic of the dynamic QoS configuration system 200 to prioritize services, activities or applications of the wireless device 120. In some embodiments, a user interface displayed through processing of the dynamic QoS configuration system 200 may allow manipulation to manually request a dynamically configured QoS. The dynamic QoS configuration system 200 may further include other components such as a power management unit, a control interface unit, etc.

The location of the dynamic QoS configuration system 200 may depend upon the network architecture. As set forth above, the dynamic QoS configuration system 200 may be located in the wireless device 120. However, further functionality may be located in the RAN 170 or in a separate processing node. Thus, although shown as a single integrated system, various additional functions of the dynamic QoS configuration system may be separated and disposed in separate locations.

Accordingly, the wireless device 120 includes a memory 220 storing instructions and data. The data may include, for example, data learned through implementation of the required flow learning logic 202 and bearer learning logic 204. The wireless device 120 further includes at least one processor 210 executing the stored instructions including the required flow learning logic 202, the bearer learning logic 204 and the QoS request logic 206. The required flow learning logic 202 may learn flow requirements of applications, activities, and services, including for example, learning of low latency, low loss, and scalable throughput (L4S) requirements. The bearer learning logic 204 may determine and store characteristics of each provided bearer, which may include, for example, the QoS provided by the bearer. The QoS request logic 206, may be triggered upon finding that certain thresholds have been reached. For example, when a flow requirement of an application or activity requires a latency below a predetermined threshold, the QoS request logic 206 may be triggered to request a dedicated bearer from the access node 110.

Accordingly, by utilizing the dynamic QoS configuration system 200, the wireless device 120 enables learning, by the artificial intelligence markup language (AIML) chip 208 on the wireless device 120, one or more flow requirements of activities performed by the wireless device within a wireless network during a PDU session. Further, the wireless device determines by the AIML chip 208, a corresponding target quality of service (QoS) for each activity performed by the wireless device 120 during the PDU session. Additionally, the AIML chip 208 triggers a request from the wireless device 120 for the corresponding target QoS for the activities performed during the PDU session when the corresponding target QoS differs from a default QoS.

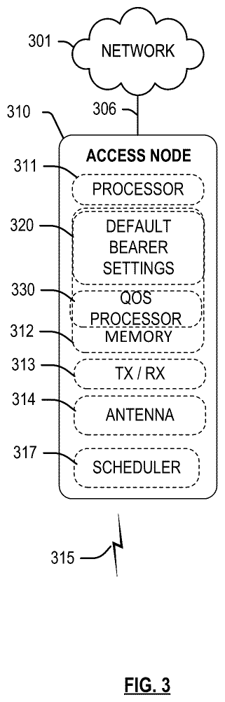

FIG. 3 depicts an exemplary access node 310. The access node 310 may be a more specific rendering of the access node 110. Access node 310 is configured as an access point for providing network services from network 301 to end-user wireless devices such as wireless device 120. Access node 310 is illustrated as comprising a memory 312 for storing logical modules that perform operations described herein, a processor 311 for executing the logical modules, and a transceiver 313 for transmitting and receiving signals via one or more antennas 314. Combinations of antennas 314 and transceivers 313 are configured to deploy wireless air interfaces. Further, the different sets of antennas can be used to implement various transmission modes or operating modes in each sector, including but not limited to multiple in multiple out (MIMO), carrier aggregations, and different duplexing modes including frequency division duplexing (FDD) and time division duplexing (TDD). Further, access node 310 deploys different bearers for communication with the wireless device 120, wherein the different bearers have different characteristics. The access node 310 is communicatively coupled to network 301 via communication interface 306, which may be any wired or wireless link as described above. Scheduler 317 may be provided for scheduling resources for the wireless device 120. Wireless communication link 315 may facilitate communication with the wireless devices 120 in both uplink and downlink directions.

In an exemplary embodiment, memory 312 includes default bearer settings 320 as well as a QoS processor 330. The default bearer settings 320 represent default settings for bearers generally deployed for communication with the wireless device 120. The QoS processor 330 may be triggered by a request for a bearer received from the dynamic QoS configuration system 200. For example, when the dynamic QoS configuration system 200 of the wireless device 120 determines that an application requires lower latency than the latency provided by a default bearer, the wireless device 120 sends a request to the access node 310 to deploy a dedicated bearer for the application and the request is processed by the QoS processor 330. The QoS processor 330 may, for example, determine whether the RAN 170 has sufficient resources available to deploy the requested dedicated bearer. When the QoS processor 330 finds that the RAN includes sufficient resources, the QoS processor 330 may deploy a dedicated bearer for the application utilized by the wireless device 120. Conversely, when the QoS processor 330 finds that the RAN does not have sufficient resources to deploy a dedicated bearer, the QoS processor 330 denies the request made by the dynamic QoS configuration system 200 and instead deploys a default bearer as defined by the default bearer settings 320.

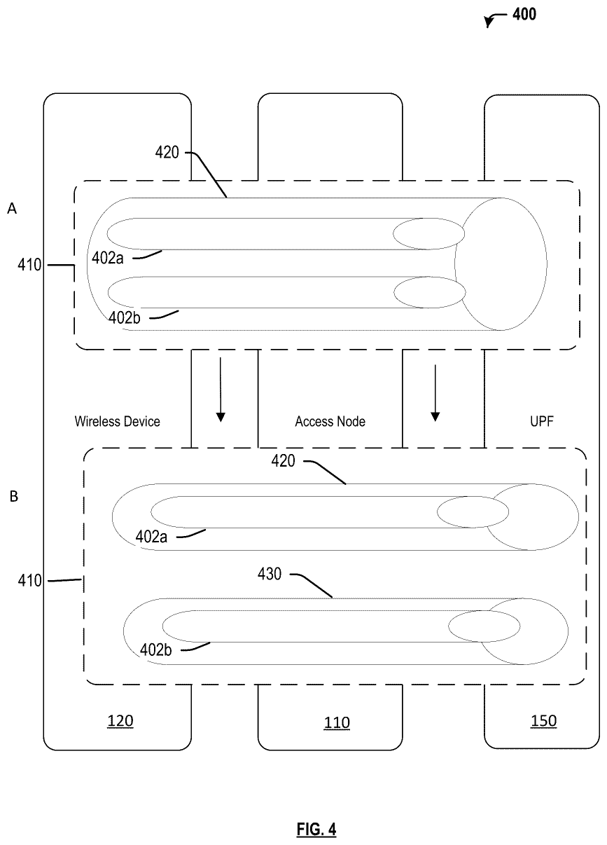

FIG. 4 depicts a further exemplary environment 400 for dynamic QoS configuration in accordance with an embodiment. More specifically, FIG. 4 illustrates a PDU session 410. The core network 102 establishes the PDU session 410 for the wireless device 120. As illustrated in Part A of FIG. 4, the PDU session 410 may be established with a single bearer 420. However, the single bearer 420 may include multiple data flows 402a and 402b due to multiple applications or activities utilized by the wireless device 120. The data flows 402a and 402b may be classified and marked using a QoS flow identifier (QFI). In embodiments provided herein, the QFI for data flow 402a is different from the QFI for data flow 402b. Because these multiple data flows 402a and 402b utilize the same bearer 420 within the PDU session 410, the multiple data flows 402a and 402B receive the same QoS.

However, as illustrated in Part B of FIG. 4, when the dynamic QoS configuration system 200 operates to trigger a request from the wireless device 120 to the access node 110 for a dedicated bearer based on the different flow requirements learned and determined with respect to the wireless device 120, the configuration may be altered to include an additional bearer 430 during the PDU session 410 for the data flow 402b. For example, the dynamic QoS configuration system 200 may find that the data flow 402a is a browsing session, but that the data flow 402b is a voice call. Thus, the wireless device user may be simultaneously browsing and executing a voice call. Because the voice call requires a higher QoS that the browsing session, the dynamic QoS configuration system 200 may trigger a request from the wireless device 120 to the access node 110 for a dedicated bearer. When the access node 110 finds that the RAN 170 has available resources for a dedicated bearer, the access node 110 may deploy the dedicated bearer 430 for the data flow 402b within the PDU session 410 resulting in the configuration shown in Part B.

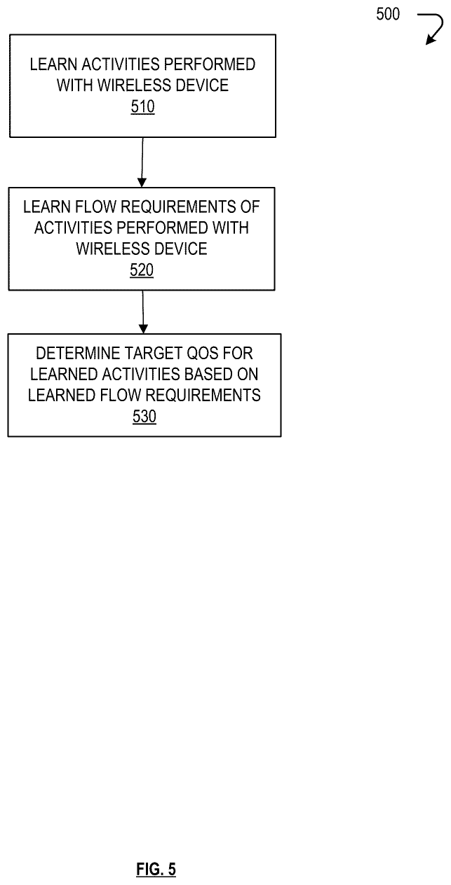

FIG. 5 illustrates an exemplary method 500 for operation of the dynamic QoS configuration system 200. Method 500 may be performed by any suitable processor discussed herein, for example, the processor 210 included in the wireless device 120. For discussion purposes, as an example, method 500 is described as being performed by the processor 210 included in the wireless device 120.

Method 500 starts in step 510, in which the processor 210 operates in conjunction with the required flow learning logic 202 to learn activities performed with the wireless device 120. For example, the required flow learning logic 202 and the processor 210 may learn that the wireless device 120 performs activities including internet browsing, gaming, voice calls, online meetings, streaming video, augmented reality (AR), virtual reality (VR), messaging applications, or file transfer applications. The activities may be executed for example, through online applications or mobile applications.

In step 520, the processor 210 and the required flow learning logic 202 may learn flow requirements of the above-described applications and activities. For example, flow requirements may include latency requirements, throughput requirements, bandwidth requirements, or guaranteed bit rate (GBR) requirements. The processor 210 and required flow learning logic 202 may further learn flow requirements such as packet size and delay including one way delay and round trip delay. The delays may involve processing delays, queuing delays, or propagation delays. The processor 210 and flow learning logic 202 may further monitor jitter or the variation of one-way delay in a stream of packets. Further, the processor 210 and the flow learning logic 202 may monitor loss, which is the amount of lost data. The amount of loss data may be represented by a percentage of packets sent.

Additionally, the processor 210 and learning logic 202 may bundle and categorize applications and activities that have similar flow requirements. The learning logic 202 enables the AIML chip 208 to become familiar with and categorize the different flows and different applications and bundle those with similar requirements. In embodiments provided herein, the processor 210 and the required flow learning logic 202 may learn the required flows in the uplink direction only, while in other embodiments, the required flows in both directions may be learned.

In step 530, the processor 210 and the required flow learning logic 202 may determine a target QoS for each of the above described activities based on the learned flow requirements. For example, the processor 210 and the required flow learning logic 202 may determine that voice applications require a highest QoS, gaming applications require a next highest QoS. Other applications and activities such as video, web surfing, email applications, and file transfer applications may not require an elevated QoS and may instead be served by a default QoS. Further, the processor 210 and the required flow learning logic 202 may determine a corresponding target QoS for multiple current activities during a session. In embodiments described herein, the QoS may be applied in the UL direction only, between the wireless device 120 and the access node 110. In further embodiments, the QoS may be applied both in UL and downlink (DL) directions. As an example, for real time gaming, the required flow learning logic 202 and processor 210 may determine that high throughput is required on the downlink and low latency on the uplink because of the control signaling from the wireless device on the uplink.

Accordingly, the required QoS on the uplink and downlink may differ.

The different levels of QoS may include, for example be represented by different quality class identifiers (QCI) or 5G quality of service identifiers (5QI). Existing QCIs and 5QIs include 1-9. QCIs and 5QIs are generally allocated by network service providers by default. For example, guaranteed bit rate (GBR) traffic is often assigned to 5QIs or QCIs 1-4 and non-GBR traffic is therefore assigned to 5QIs or QCIs 5-9. GBR traffic includes, for example voice calls, video calls, live gaming, and video streaming. Non-GBR traffic includes, for example, file transfer applications and buffered video. QCI and 5QI values are based on requirements including latency, packet loss, and reliability.

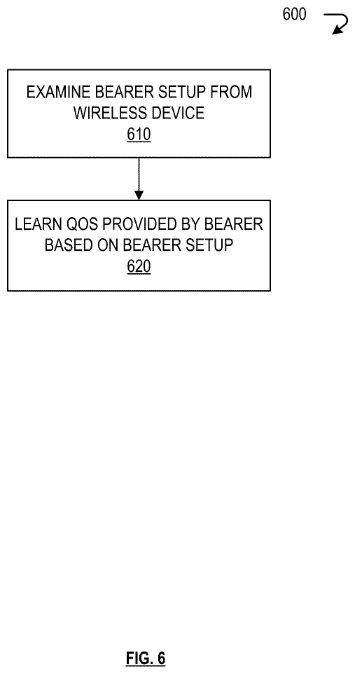

FIG. 6 illustrates an exemplary method 600 for operation of the dynamic QoS configuration system 200. Method 600 may be performed by any suitable processor discussed herein, for example, the processor 210 included in the wireless device 120. For discussion purposes, as an example, method 600 is described as being performed by the processor 210 included in the wireless device 120.

Method 600 starts in step 610, in which the processor 210 operates in conjunction with the bearer learning logic 204 to examine bearer setup from the wireless device. For example, the processor 210 and bearer learning logic 204 examine a bearer setup from the artificial intelligence markup language (AIML) chip 208 of the wireless device to determine a bearer priority and characteristics of traffic flow template (TFT) filters. The TFT filters are flow control mechanisms that provide functionality for management of the QoS in UL data transmission. The ultimate goal of the TFT flow control mechanisms is to avoid receive buffer overruns, which improves data transmission reliability, whereas the QoS is concerned with the treatment of frames or packets on the network side. QoS parameters include, for example, a QoS identifier (5G QI), Internet protocol (IP) Data Flow (QoS flow), QoS flow identifier (QFI), reflective QoS, and data session.

In particular, the processor 210 and bearer learning logic 204 examine a radio bearer, which is a logical channel between the wireless device 120 and the access node 110. The radio bearers also connect the RAN 170 with the core network 102 to allow seamless data transfer. The radio bearer may include both control radio bearers that handle control signaling and data radio bearers that transport of user data. Each bearer has a unique ID and quality of service parameters.

The method continues in step 620, in which the processor 210 and the bearer learning logic 204 learn the QoS provided by the bearer based on the bearer setup including the QoS parameters identified in step 610.

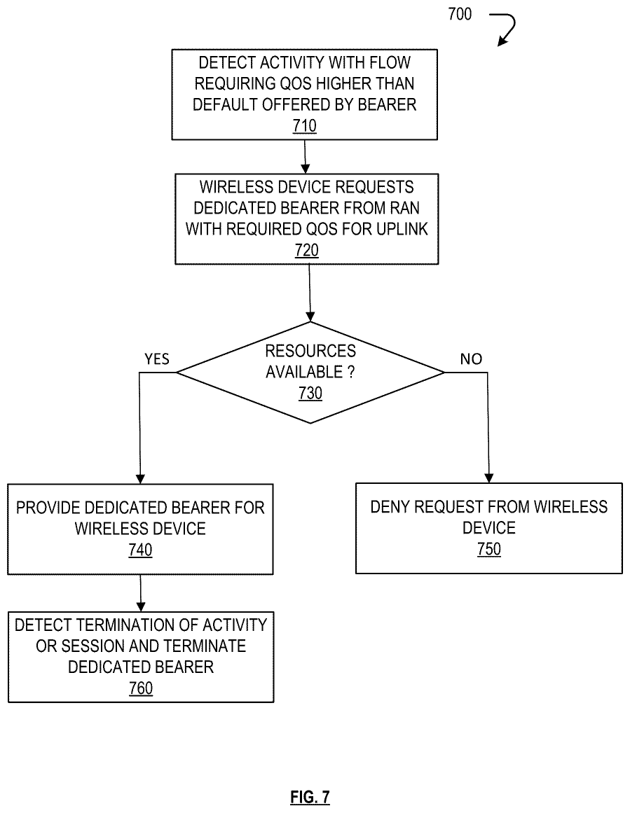

FIG. 7 illustrates an exemplary method 700 for operation of the dynamic QoS configuration system 200 after learning of flow requirements for activities and applications and bearer characteristics as explained with reference to FIGS. 5 and 6. Method 700 may be performed by any suitable processor discussed herein, for example, the processor 210 included in the wireless device 120. For discussion purposes, as an example, method 700 is described as being performed by the processor 210 included in the wireless device 120.

Method 700 starts in step 710, in which the processor 210 operates in conjunction with the dynamic QoS configuration system 200 including the bearer request logic 206 to detect activities requiring a QoS higher than the QoS provided by the default bearer. In order to make this determination, the bearer request logic may compare the required QoS to a current default QoS. If the required QoS determined based on the flow is higher than the current default QoS, in step 720, the processor 210 may trigger a request for a dedicated bearer from the RAN 170 with the required QoS for the identified activities or applications on the uplink. Further, multiple requests may be triggered from the wireless device 120 for the corresponding target QoS for multiple activities during the session. Thus, the AIML on the SoC 208 can learn different flows characteristics and requirements and request corresponding unique bearers to be established in the UL direction for specific flows without having to use a different DNN.

In step 730, the access node 110 may determine whether the RAN 170 has the resources available to provide the dedicated bearer. If the resources are available in step 730, the access node may provide a dedicated bearer for the wireless device 120 in step 740. However, if the resources are not available in step 730, the access node 110 may deny the request for the dedicated bearer in step 750 and all activities and applications in a current PDU session may be served by a default bearer.

In the instance in which the dedicated bearer is provided in step 740, the processor 210 may determine that a session has ended in step 760, for example, by detecting idle time over a threshold time. For example, if a wireless device 120 is idle for more than five seconds, the processor 210 may detect this, determine the session has ended, and instruct the access node 110 to terminate the dedicated bearer and return to defaults. In some embodiments, the access node 110 may determine that the activity requiring the higher QoS has been terminated and return to default QoS even when the session is still active. For example, a wireless device user may finish playing a game, but still have a browsing session. Because the higher QoS is not needed for the browsing session, the processor 210 may detect that the game has been inactive and instruct the access node 110 to terminate the dedicated bearer after the game has been inactive for a threshold time period even though the browsing session is still active. When the gaming application is no longer active, resources can be freed up on the RAN and at the core network.

In some embodiments, methods 500, 600, and 700 may include additional steps or operations. Furthermore, the methods may include steps shown in each of the other methods.

Additionally, the order of steps shown is merely exemplary and the steps may be re-ordered as appropriate. As one of ordinary skill in the art would understand, the methods 500, 600, and 700 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
learning, by a wireless device, flow requirements of an activity performed in a wireless network by the wireless device;
determining a target quality of service (QoS) for the activity based on the flow requirements;
determining the target QoS exceeds a default QoS provided by a radio access network (RAN); and
triggering a request from the wireless device to the RAN for a dedicated bearer within an established protocol data unit (PDU) session, the dedicated bearer providing the target QoS for the activity.

2. The method of claim 1, wherein the activity comprises execution of a mobile application.

3. The method of claim 1, wherein the activity comprises a voice call.

4. The method of claim 1, wherein the flow requirements include low latency, high throughput, high bandwidth, a predetermined packet size, or guaranteed bit rate (GBR).

5. The method of claim 1, wherein the learning, determining, and triggering are performed by an artificial intelligence markup language (AIML) chip.

6. The method of claim 1, further comprising examining a bearer setup from an artificial intelligence markup language (AIML) chip of the wireless device to determine a bearer priority and traffic flow template (TFT) filters.

7. The method of claim 1, further comprising triggering the request from a modem of the wireless device.

8. The method of claim 7, wherein the modem requests the dedicated bearer with the target QoS.

9. The method of claim 1, wherein the target QoS applies to uplink traffic.

10. The method of claim 1, further comprising determining a corresponding target QoS for multiple current activities during the established PDU session.

11. The method of claim 10, further comprising triggering multiple requests from the wireless device to the RAN for the corresponding target QoS for each activity during the established PDU session.

12. A wireless device comprising:
a memory storing multiple mobile applications;
a processor incorporating artificial intelligence markup language (AIML) performing operations including;
learning flow requirements of an activity of the wireless device;
determining a target quality of service (QoS) for the activity based on the flow requirements;
determining the target QoS exceeds a default QoS provided by a radio access network (RAN); and
triggering a request from the wireless device to the RAN for a dedicated bearer within an established protocol data unit (PDU) session, the dedicated bearer providing the target QoS for the activity.

13. The wireless device of claim 12, wherein the activity includes execution of one of the stored mobile applications.

14. The wireless device of claim 12, wherein the request is triggered from a modem of the wireless device.

15. The wireless device of claim 14, wherein the modem requests the dedicated bearer with the target QoS.

16. The wireless device of claim 12, wherein the target QoS applies to uplink traffic.

17. The wireless device of claim 12, wherein the operations comprise determining the corresponding target QoS for multiple current activities during the established PDU session and triggering multiple requests from the wireless device to the RAN for the corresponding target QoS for each activity during the PDU session.

18. A method comprising:
learning, by an artificial intelligence markup language (AIML) chip on a wireless device, flow requirements of activities performed by the wireless device within a wireless network during an established protocol data unit (PDU) session;
determining, by the AIML chip, a corresponding target quality of service (QoS) for each activity performed during the established PDU session;
determining the corresponding target QoS exceeds a default QoS provided by a radio access network (RAN); and
triggering a request from the AIML chip to the RAN for a dedicated bearer within the established protocol data unit (PDU) session, the dedicated bearer providing the corresponding target QoS for the activities performed during the established PDU session when the corresponding target QoS exceeds the default QoS.

19. The method of claim 18, further comprising receiving the corresponding target QoS during the established PDU session.

20. The method of claim 19, further comprising receiving the default QoS after termination of the established PDU session.
